(19) United States
(12) Patent Application Publication
(10) Pub. No.: US 2005/0196656 A1
(43) Pub. Date: Sep. 8, 2005

(54) Fuel cell

(76) Inventor: Rodolfo Antonio M. Gomez, Adelaide (AU)

Correspondence Address: KLAUBER & JACKSON, 411 HACKENSACK AVENUE, HACKENSACK, NJ, 07601, US

(21) Appl. No.: 11/005,556

(22) Filed: Dec. 6, 2004

Related U.S. Application Data
(63) Continuation-in-part of application No. 10/474,340, filed on Oct. 8, 2003.

(30) Foreign Application Priority Data
Dec. 8, 2003 (AU) 2003906746
Feb. 17, 2004 (AU) 2004900745
Mar. 22, 2004 (AU) 2004901465

(51) Int. Cl. H01M 8/10; H01M 4/86; H01M 4/92; H01M 8/02

(52) U.S. Cl. 429/30; 429/40; 429/38; 429/13

(57) ABSTRACT

A process and apparatus to modify the conventional proton exchange fuel cell by applying a non-conductive proton exchange material (5), a separate semiconductor (8), cylindrical-conical fuel cell elements (1,3), and internally stacking the fuel cell elements by a simple method. These modifications in the operating principle and construction configuration of the proton exchange fuel cell are designed to result in a major increase in the power density output necessary for transport vehicle and stationary power generation applications.

### REFERENCE TO RELATED APPLICATIONS

This application is a Continuation-In-Part of U.S. patent application Ser. No. 10/474,340 dated 9 Apr. 2002, which in turn claims priority from Australian Patent Application No. 2003906746 filed 8^{th} December 2003, Australian Patent Application No. 2004900745 filed 17 Feb. 2004 and Australian Patent Application No. 2004901465 filed 22 Mar. 2004. Applicants claim the benefits of 35 U.S.C. §120 as to the said U.S. Application and priority under 35 U.S.C. §119 as to said Australian applications, and the entire disclosures of all applications are incorporated herein by reference in their entireties.

### FIELD OF INVENTION

This invention relates to a modified operating principle, construction and configuration of fuel cells and a method of internal stacking of the fuel cell elements to produce higher power density to make fuel cells suitable for use in transport vehicles and for small to large stationary electric power generation units.

The invention will be particularly discussed with reference to the proton exchange fuel cell using hydrogen fuel but is also applicable to other fuels and to other types of fuel cells such as solid oxide fuel cells.

### PRIOR ART

Fuel cells under development during the last four decades include the phosphoric acid fuel cell, the proton electrolytic membrane fuel cell, the molten carbonate fuel cell and the solid oxide fuel cell. While phosphoric acid fuel cells up to 250 kilowatts capacity are commercially available, the most advanced fuel cell is the proton electrolytic membrane fuel cell, however, its further commercial application is limited by the low power density of current designs and reported highest power capacity for transport vehicles and stationary power generation units is about 300 kilowatts.

This invention consists of modifying the operating principle and the construction of the proton electrolytic membrane fuel cell and a method of internal stacking of the fuel cell elements to increase the power density of the fuel cell group so that it is suitable for application to transport vehicles and small and large stationary power generation. The objective is about 85 to 120 kilowatts for small transport vehicles and 300 to 400 kilowatts for large transport vehicles. In stationary power generation, the objective is to provide 3 to 5 kilowatts for home use, 250 kilowatts and 1,000 kilowatts for dispersed community power requirements and 10,000 to 500,000 kilowatts for centralized power generation.

Most proton electrolytic membrane fuel cells are planar in construction such as the Ballard Power fuel cell where the fuel cell elements have been “stacked” in a neat cubical configuration. Passageways are provided for the supply of hydrogen and oxygen and the removal of the reaction products. The disadvantage of this construction is that pressure on the hydrogen side is limited as high pressure may cause rupture and seal failure allowing the hydrogen to mix directly with the oxygen with catastrophic results.

A cylindrical cell construction would offer the possibility of higher pressure differential between the hydrogen side and the oxygen side. Several U.S. patents have been granted for proton electrolytic membrane fuel cells that are cylindrical in shape such as:
U.S. Pat. No. 5,458,989 (Oct. 17, 1995)—Tubular fuel cells with structural current collectors—Dodge, C. et al,
U.S. Pat. No. 5,509,942 (Apr. 23, 1996)—Manufacture of tubular fuel cells with structural current collectors—Dodge C. et al,
U.S. Pat. No. 6,001,500 (Dec. 14, 1999)—Cylindrical proton exchange membrane fuel cells and methods of making same—Bass E. et al,
U.S. Pat. No. 6,007,932 (Dec. 28, 1999)—Tubular fuel cell assembly and method of manufacture—Steyn W. et al,
U.S. Pat. No. 6,060,188 (May 9, 2000)—High pressure coaxial fuel cell—Muthuswamy S. et al, and
U.S. Pat. No. 6,063,517 (May 16, 2000)—Spiral wrapped cylindrical proton exchange membrane fuel cells and method of making same—Montemayor A. et al.

The proton electrolytic membrane fuel cells above describe several cylindrical configurations of the proton electrolytic membrane fuel cell. A major shortcoming of the above construction is how to maintain good contact between the proton exchange membrane and the anode and cathode electrodes under all operating conditions of the proton electrolytic membrane fuel cell, particularly under varying temperatures. Loosening of the contact between the membrane and the electrodes would increase the impedance of the proton electrolytic membrane fuel cell and even cause the proton electrolytic membrane fuel cell to cease functioning.

U.S. Pat. No. 5,244,752 (Sep. 14, 1993)—Apparatus tube configuration and mounting for solid oxide fuel cell—Zymboly, G. concerns a tubular configuration for a solid oxide fuel cell.

The proton membrane fuel cell described in U.S. patent application Ser. No. 10/474,340 operates with a proton membrane that is also a semi-conductor that allows electric current to flow from the cathode electrode to the anode electrode only. The proton exchange membrane is described as a homogenous membrane that allows the hydrogen proton to move from the anode electrode to the cathode electrode and electrons to travel from the cathode electrode to the anode electrode.

The proton membrane fuel cell described in U.S. patent application Ser. No. 10/474,340 shows the oxygen-nitrogen mixture or air passing from the first fuel cell to the last fuel cell of a stack of fuel cells.

It is an objective of this invention to present a further improvement to the structure and features of fuel cells of this type.

### BRIEF DESCRIPTION OF THE INVENTION

In one form therefore the invention is said to reside in a proton exchange fuel cell comprising an anode, a cathode, a proton exchange material between the anode and the cathode that allows movement of hydrogen ions from the anode to the cathode and a separate semiconductor arrangement electrically connected to the anode and the cathode and which allows movement of electrons from the cathode to the anode.

Preferably the proton exchange material is fused to the anode and the cathode. The proton exchange material may be fused to the anode and the cathode by a process selected from the group comprising gluing, welding, brazing and soldering.

Preferably the anode has a catalytic surface adapted to catalyze hydrogen to hydrogen ions. The anode catalytic surface may be fine platinum.

Preferably the cathode has a catalytic surface. The cathode catalytic surface may be selected from the group comprising platinum and nickel.

The anode may comprise a frusto-conical surface on an inner surface thereof and the cathode may comprise a frusto-conical surface on an outer surface thereof and matching the frusto-conical inner surface of the anode, the proton exchange material being held between the frusto-conical inner surface and the frusto-conical outer surface.

In a further form the invention comprises a fuel cell comprising an anode cell and an anode at one wall thereof, a cathode cell and a cathode at one wall thereof and a proton exchange material between the anode cell and the cathode cell and engaged against the anode and the cathode and a separate semiconductor electrically connected to the anode and the cathode and which allows movement of electrons from the cathode to the anode.

Preferably the cathode and anode are formed from a material which allows easy passage of hydrogen ions. The cathode and anode may be formed from a material selected from the group comprising carbon, metal hydrides, metal carbides or alloys thereof.

Preferably the anode is formed from a material which allows easy passage of hydrogen and the anode has a catalytic surface engaged against the proton exchange material.

The proton exchange material may be selected from a group comprising a polymer, a rubber or a ceramic.

A surface of each of the anode and cathode not being the faces engaged against the proton exchange material may have an increased surface area by means including grooving, pyramiding or roughening of the surface.

In a further form the invention comprises a proton exchange fuel cell arrangement comprising a plurality of fuel cell elements, each fuel cell element comprising an anode, a cathode, a proton exchange material between the anode and the cathode that allows movement of hydrogen ions from the anode to the cathode and a separate semiconductor arrangement electrically connected to the anode and the cathode and which allows movement of electrons from the cathode to the anode, and the fuel cell arrangement comprising a simple internal stacking of the fuel cell elements in a cylindrical cell container to allow high pressure hydrogen operation of the fuel cell arrangement.

The proton exchange fuel cell arrangement may further comprise means to supply pressurized hydrogen to the anode.

The proton exchange fuel cell arrangement may further comprise a manifold within the cylindrical cathode to supply air or oxygen to each of the fuel cell elements.

The manifold may comprise means to provide good contact between the oxygen or air and the cathode surface.

Preferably there is a first manifold within the cylindrical cathode to supply air or oxygen to each of the fuel cell elements and a second manifold within the cylindrical cathode to remove waste products from each of the fuel cell elements.

Preferably the proton exchange fuel cell arrangement comprises the fuel cell elements electrically connected in series. Alternatively the fuel cell elements may be electrically connected in parallel.

There may be included annular non-conducting seals between the fuel cell elements, the seals incorporating electrical connections between the adjacent fuel cells.

There may be included force application means on the stack of fuel cell elements to promote sealing at each of the annular seals and to promoting engagement of the respective anodes and cathodes to the proton exchange material therebetween.

In a further form the invention comprises a process to produce electricity from the reaction of hydrogen and oxygen to produce water in a proton exchange fuel cell arrangement as discussed above, the process including the steps of:
a) pressurizing hydrogen at the outer catalyst surface of the outer cylindrical anode;
b) catalyzing the hydrogen to hydrogen ions and electrons at the outer catalyst surface of the outer cylindrical anode wherein the electrons travel from the anode to an external electrical circuit through an electrical load to an inner cylindrical cathode through the semiconductor to the anode and the hydrogen ions travel through the anode, the proton exchange material between the anode and the cathode and the cathode to an inner catalytic surface of the cathode; and
c) reacting the hydrogen ions with oxygen at the inner catalytic surface of the cathode to produce water.

The hydrogen may be at a pressure of up to 333 bars at the anode and the oxygen may be provided at a pressure up to 10 bars at the cathode.

The proton exchange fuel cell arrangement can be operated at a temperature of up to 250° C.

### BRIEF DESCRIPTION OF THE DRAWINGS

This then generally describes the invention but to assist with understanding of the invention reference will now be made to the accompanying drawings which show preferred embodiments of the invention.

In the drawings:

FIGS. 1A and 1B show schematic views of proton exchange fuel cells with a proton exchange materials and a separate semiconductor arrangement according to various embodiments of the invention;

FIG. 2 shows a cross section of an embodiment of a fuel cell according to one embodiment of this invention;

FIG. 3 shows a cross section of a stack of fuel cells of the type shown in FIG. 2;

FIG. 4 shows a cross section of an alternative embodiment of a stacked fuel cell according to the invention; and

FIG. 5 shows a still further embodiment of a fuel cell stack according to the invention.

### DETAILED DESCRIPTION OF THE PREFERRED EMBODIMENTS

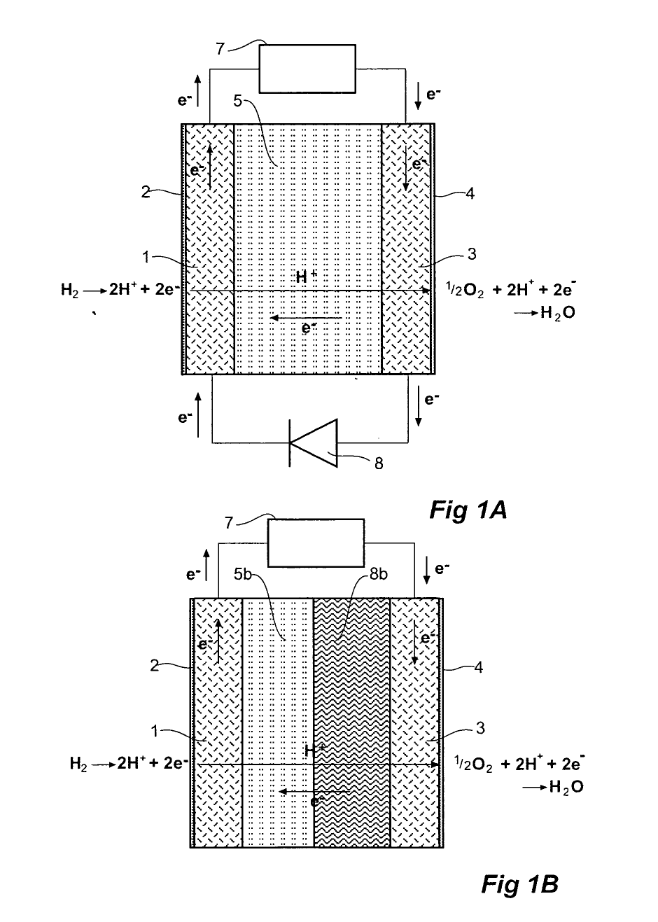

The operating principle of various embodiments of the proton exchange fuel cell according to the present invention is shown in schematic views in FIGS. 1A and 1B.

Referring to FIG. 1A, the fuel cell element has an anode 1 and a cathode 3 separated by a homogenous proton exchange material 5 wherein the proton exchange material is a material which allows protons to pass therethrough from the anode to the cathode but is electrically non-conductive. A separate semiconductor 8 is connected between the cathode 3 and anode 1. Each of the anode 1 and the cathode 3 have a catalytic surface 2 and 4 respectively. The catalytic reaction at the anode converts hydrogen to hydrogen ions or protons and these are allowed to travel from the anode 1 through the proton exchange material 5 to the cathode 3 while electrons produced are allowed to travel to the external load 7 then to the cathode 3 and then through the separate semiconductor 8 to the anode 1. This provides a complete electronic circuit. The semiconductor 8 is illustrated as a diode oriented to allow electron flow from the cathode to the anode.

The chemical reactions in the cell are as follows. Hydrogen is provided at the anode and is catalysed in the following reaction:
H₂→2H⁺+2e⁻

At the cathode oxygen is supplied and the reaction is catalysed as follows:
½O₂+2H⁺+2e⁻→H₂O

The proton exchange material that allows the hydrogen ions or protons to pass from the anode to the cathode may be constructed of a homogenous polymer, rubber or ceramic material. It must be sufficiently pliable so that it will conform to the surfaces of the anode electrode and the cathode electrode with which it is in contact. Further, the material must be stable at the operating temperature and pressure of the fuel cell.

A further aspect of the invention relates to a cubical-trapezoidal configuration of the fuel cell but preferably a cylindrical-conical configuration of the fuel cell. Axial opposing forces may be applied to a fuel cell with such a configuration forcing the cathode electrode against the anode electrode with the proton exchange material sandwiched between. This will allow good contact to be maintained between the material and the anode and cathode electrodes for a proper operation of the fuel cell under all operating conditions.

The catalytic surface 2 of the anode 1 may be formed from fine platinum. The catalytic surface 4 of the cathode 3 may be formed from a material selected from the group comprising platinum and nickel.

The cathode 3 and the anode 1 may be formed from a material which allows easy passage of hydrogen and hydrogen ions and the catalytic surface 2 of the anode may be engaged against the proton exchange material 5. The cathode 3 and anode 1 may be formed from a material selected from the group comprising carbon, metal hydrides, metal carbides or alloys thereof.

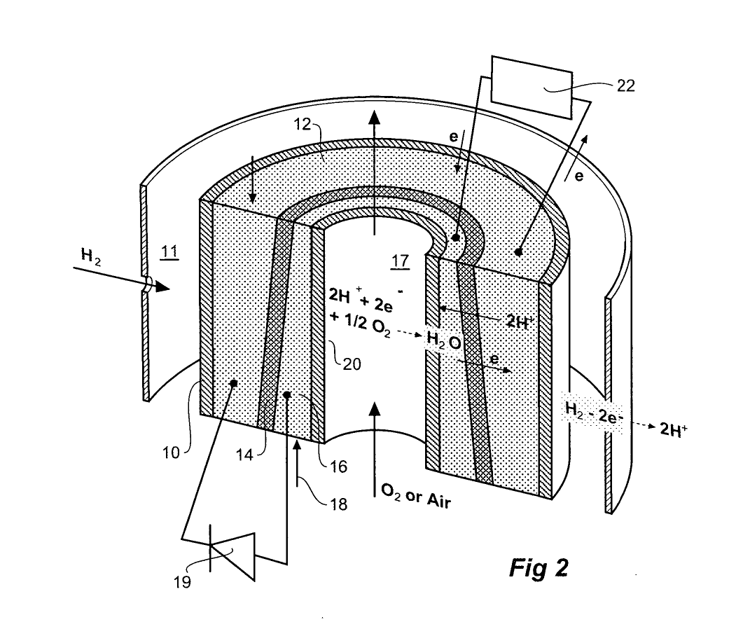

In one embodiment a fuel cell constructed according to the principle shown in FIG. 1A may have frusto-conical engaging surfaces of the anode and cathode with the anode and cathode compressed together with the proton exchange material sandwiched between them as will be discussed in relation to the various embodiments shown in FIGS. 2 to 5. An alternative embodiment can have the proton exchange material fused to the anode and cathode on its opposite sides respectively and providing good electrical connection between them. This embodiment would not require forcing together of the anode and cathode to give good electrical contact.

Referring to FIG. 1B, the fuel cell element has an anode 1 and a cathode 3 separated by both a homogenous proton exchange material 5b wherein the proton exchange material is electrically conductive and a separate semiconductor layer 8b which only allows electron flow from the cathode to the anode. Both the proton exchange material 5 and the semiconductor layer 8b allow transfer of protons from the anode to the cathode. Each of the anode 1 and the cathode 3 have a catalytic surface 2 and 4 respectively. The catalytic reaction at the anode converts the hydrogen to hydrogen ions or protons and these are allowed to travel from the anode 1 through the proton exchange material 5c and the semiconductor layer 8b to the cathode 3 while electrons produced are allowed to travel to the external load 7 then to the cathode 3 and then through the semiconductor layer 8b and the proton exchange material 5b to the anode 1. This provides a complete electronic circuit.

As discussed above the proton exchange material may be connected to the anode and the cathode by fusing. The term fusing in intended to mean the use of a conductive glue, sintering, fusing, soldering, brazing or resistance welding. If the anode and cathode and the proton exchange are well connected, it may not be necessary to provide a differential force between the anode and the cathode to maintain a firm contact with the proton exchange. Only a force compressing the fuel cell elements against seals may be required in stacking the fuel cell elements to prevent mixing of the hydrogen or fuel and the oxygen or oxidant. This construction will also allow a higher temperature to be used in the operation of the fuel cell leading to increased capacity. The anode catalyst may be located at the anode outer surface or between the anode and the proton exchange component.

FIG. 2 shows the preferred construction of one embodiment of a cell element of a cylindrical-conical fuel cell.

In this embodiment the anode catalyst 10 is located outside of the anode electrode 12 in a cylindrical anode cell 11. Where the hydrogen fuel has impurities such as carbon oxides, the anode catalyst may be located in the inside of the anode electrode. As shown in FIG. 2, the cylindrical anode electrode 12 with the anode catalyst 10 located on the outer surface is slightly conical on the inside. In an alternative arrangement a layer of material may be installed over the catalyst layer to screen out any carbon oxides in the fuel which would otherwise poison the catalyst. The proton exchange material 14 is also slightly conical and fits into the inside of the anode electrode 12. The outer surface of the cylindrical cathode electrode 16 is slightly conical and fits into the cone of the proton exchange material 14 and the inside cone of the anode electrode 12. The cathode electrode 16 is pushed axially upward 18 while the anode electrode is restrained so that there is a force causing the inside of the anode electrode 12 to maintain contact with the outside of the cathode electrode 16 with the proton exchange material 14 sandwiched in-between. The material of the anode and cathode electrode is electrically conducting and needs to allow easy passage of the hydrogen ion and must have structural strength to withstand the high pressure differential between the hydrogen in the anode cell 11 and the air or oxygen in the cathode cell 17 at the operating temperature of the fuel cell. The inner surface of the cathode electrode 16 has a catalyst 20 on it.

A semiconductor 19 is connected between cathode 16 and the anode 12 so as to allow electron to flow from the cathode to the anode.

The anode and cathode electrodes are made of electrically conducting material such as metals, alloys, hydrides and carbon that allows easy passage of the hydrogen ion through the crystal lattice or grain boundaries of the material. There are many such materials known due to the extensive research into the use of these materials for the storage of hydrogen.

In operation, the hydrogen atom is catalyzed to hydrogen ion by the anode catalyst at the anode electrode. The electrons travel to the external circuit via the electrical load 22 and return to the cathode electrode. The hydrogen ion travels to the cathode catalyst 20 located at the inner surface of the cathode electrode 16 where the hydrogen ion reacts with the oxygen and the electrons from the external electrical circuit to form water. The electronic circuit is completed by the passage of electrons from the cathode electrode through the semiconductor 19 to the anode electrode.

The external or separate semiconductor may be in the form of a bridge or a plate shaped an sized as required to mate with the shape of the anode and cathode electrodes and to efficiently and adequately conduct the electric current of the fuel cell.

This embodiment is shown with the separate semiconductor of the type shown in schematic view of FIG. 1A but it may also be constructed with the type of semiconductor arrangement shown in FIG. 1B.

A simple model to explain the operating principle of the fuel cell is that there is a continuous flow of electrons in the electronic circuit. At the anode, electrons from the oxidation of the hydrogen join this electronic circuit. The hydrogen ion travels to the cathode. At the cathode, some electrons are used by the cathode reaction to carry out the reaction forming water from the hydrogen ions and the oxygen available at the catalyst surface of the cathode electrode.

The cylindrical-conical construction allows a large pressure differential between the anode (hydrogen) and the cathode (oxygen). This creates a stronger driving force for the diffusion of the hydrogen ion due to the substantially higher concentration of hydrogen ions at the anode electrode. This will result in a higher current density for the fuel cell even without considering the higher power density of the fuel cell as a result of the complete electronic circuit provided by the semiconductor.

It is projected that the fuel cell according to the invention can operate at hydrogen pressures of up to 333 bars and up to 10 bars of air or oxygen pressure. The higher the operating temperature, the higher the diffusion rate of the hydrogen ion through the anode and cathode electrodes. The normal operating temperature of the fuel cell may range from 25° C. up to 250° C. or more. The operating temperature will be limited mainly by the materials of construction of the fuel cell.

Fuel cells can produce high currents but the voltage of each cell is theoretically 1.229 volts for the hydrogen-oxygen fuel cell and is usually lower under load in an operating system. It is desirable to connect the cells in series or “stack” these to produce a high working voltage. Alternatively they can be connected in parallel.

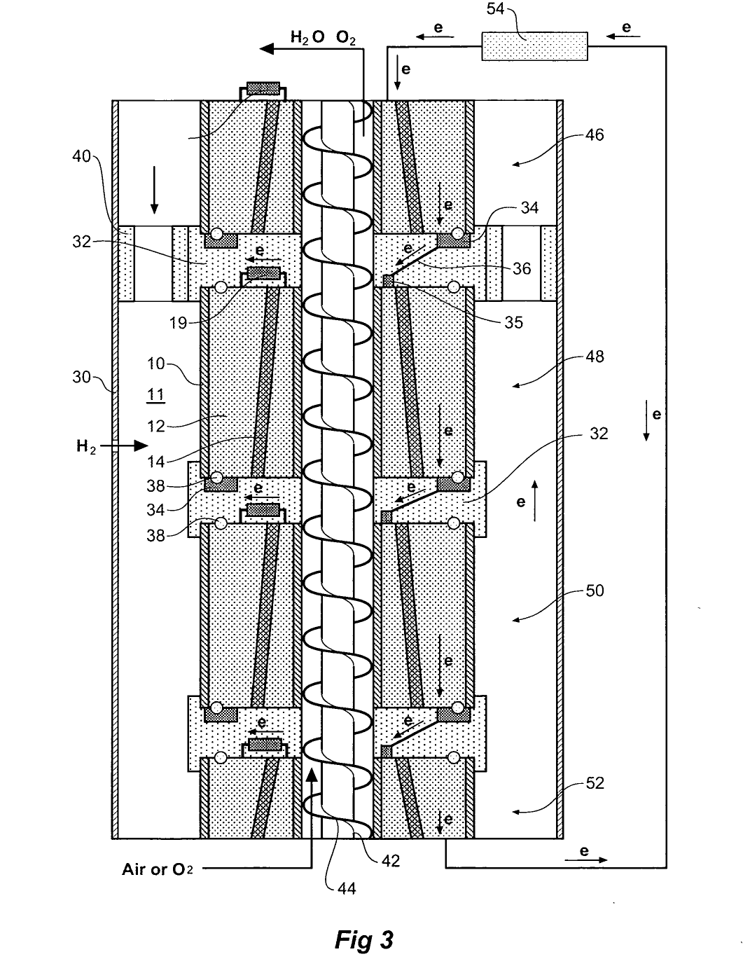

The fuel cell elements may be stacked internally as shown in an alternative embodiment in FIG. 3. Each cell is the same as that shown schematically in FIG. 2 and the same reference numerals are used for the same components.

Each fuel cell element comprises an anode 12 with an anode catalyst 10 is located outside of the anode electrode 12 in a cylindrical anode cell 30. Where the hydrogen fuel has impurities such as carbon oxides, the anode catalyst may be located in the inside of the anode electrode. The cylindrical anode electrode 12 with the anode catalyst 10 located on the outer surface is slightly conical on the inside. The proton exchange material 14 is also slightly conical and fits into the inside of the anode electrode 12. The outer surface of the cylindrical cathode electrode 16 is slightly conical and fits into the cone of the proton exchange material 14 and the inside cone of the anode electrode 12. The cathode electrode 16 is pushed axially upward 18 while the anode electrode is restrained so that there is a force causing the inside of the anode electrode 12 to maintain contact with the outside of the cathode electrode 16 with the proton exchange material 14 sandwiched in-between. The material of the anode and cathode electrode is electrically conducting and needs to allow easy passage of the hydrogen ion and must have structural strength to withstand the high pressure differential between the hydrogen in the anode cell 11 and the air or oxygen in the cathode cell 17 at the operating temperature of the fuel cell. The inner surface of the cathode electrode 16 has a catalyst 20 on it. A semiconductor 19 is connected between cathode 16 and the anode 12 so as to allow electron to flow from the cathode to the anode.

The cell elements are held in a tube 30 pressurized with hydrogen. Each cell element is electrically isolated by a non-conducting annular ring 32 that is made of a plastic or ceramic material. An outer annular conducting ring 34 in contact with the anode electrode and an inner annular conducting ring 35 in contact with the cathode electrode are imbedded in the non-conducting ring. These two rings are connected by a conductor wire 36 imbedded in the non-conducting annular ring 32. Sealing O-rings 38 or similar are installed between the anode electrode 12 and the non-conducting annular ring 32 to separate the hydrogen from the oxygen. The dimension and compressibility of the inner and outer conducting rings and the O-ring seals selected so that when a compressive force is applied to the fuel cell elements, the anode electrodes are forced against the annular ring 32 to seal against it and at the same time achieve sealing of the hydrogen from the air or oxygen and the conical surfaces of the anode and cathode electrodes forced against each other to hold the proton exchange material in good contact.

Larger diameter non-conducting rings 40 with holes are installed at appropriate intervals to center the fuel cell elements within the cylindrical container 30. An inner cylinder 42 with continuous helical vane or baffle 44 is installed in the cathode cell cavity to ensure good contact of the air or oxygen with the cathode catalyst and to effect the efficient removal of the fuel cell reaction product.

The electronic circuit is described as follows. Starting from cell element 46, electrons travel from the cathode electrode to the anode electrode, to the outer conducting ring through the embedded wire conductor 36, to the inner conducting ring of cell element 48 to the cathode electrode of cell element 48, through the semiconductor 19 to the anode electrode of cell element 48, to the outer conducting ring through the embedded wire conductor to the inner conducting ring of cell element 50, to the cathode electrode of cell element 50, through the semiconductor 19 to the anode electrode, to the outer conducting ring through the embedded wire conductor to the inner conducting ring of cell element 52, to the cathode electrode of cell element 52, through the semiconductor 19 to the anode electrode of cell element 52, to the external conductor to the electrical load 54 and to the cathode electrode of cell element 46.

This embodiment is shown with the separate semiconductor of the type shown in schematic view of FIG. 1A but it may also be constructed with the type of separate semiconductor arrangement shown in FIG. 1B.

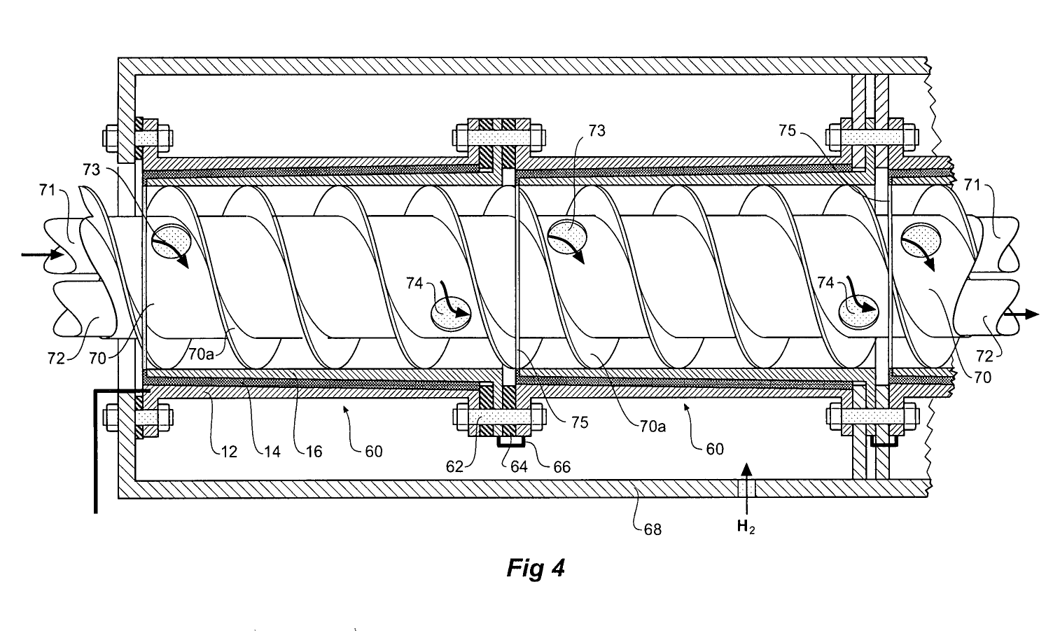

Another method of internal stacking is shown on FIG. 4. Each cell is the same as that shown in FIG. 2 and the same reference numerals are used for the same components. In this method, instead of opposing forces achieving contact between the proton exchange material and the electrodes, each fuel cell element is bolted to the next fuel cell element to achieve the force to keep the proton exchange material in contact with the electrodes.

The device consists of a plurality of fuel cells 60 each composed of an anode 12 and a cathode 16 separated by a proton exchange material 14. Each cell is connected to adjacent cells by insulated bolts 62 and compressible seals 64 are filled between the cells and electrical connection 66 is provided between the cathode of one cell and the anode of the next. Separate semiconductors (not shown) are provided to allow electron flow from the cathodes to the anodes.

The entire stack is received in a cylindrical tank 68 so that hydrogen can be pressurised around the anodes of the cells. The cylindrical inner surfaces of the cathodes are exposed to air or oxygen and a central cylinder 70 with helical baffles 70a ensures good contact of the air with the catalytic surface 20 of the cathode 16.

To ensure good supply of air or oxygen to the cathode a pair of pipes 71 and 72 extend through the central cylinder 70. The pipe 71 supplies air or oxygen to each cathode through apertures 73 and pipe 72 withdraws reaction products from each cathode through apertures 74. By this arrangement maximum concentration of oxygen can be supplied to each cell and waste products do not build up in the stack. A baffle 75 is provided between each cell to maintain oxygen concentration in each cell.

In the device shown in FIG. 4, the dimension and compression characteristics of the seals 64 are important to achieve the seal between the hydrogen and the oxygen and the force required to maintain contact between the anode electrode 12 the material 14 and the cathode electrode 16.

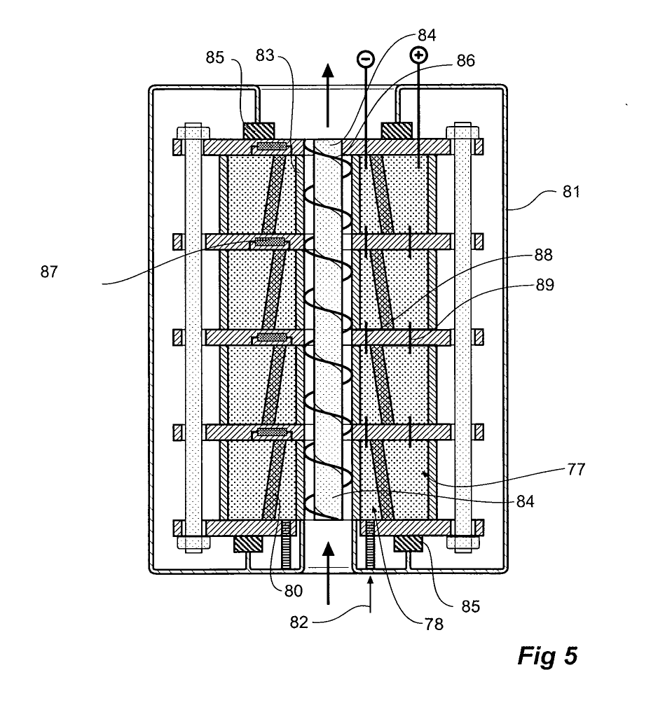

Another method of internal stacking the fuel cells is shown in FIG. 5.

The assembly in FIG. 5 shows an anode electrode stack 77 installed inside a cylindrical container 81 with seals 85 to contain hydrogen at the anode side. A cathode electrode stack 78 with matching conical dimensions are installed inside the anode electrode stack 77 with a proton exchange material 80 sandwiched between the anode electrodes and the cathode electrodes. A force 82 is applied at bottom end of the cathode electrode stack so that the cathode electrodes 78 are firmly in contact with the material 80 and the anode electrodes 74. An inner cylinder 84 with helix 86 is installed through the cathode electrode 78 stack to ensure good contact of the air or oxygen with the catalyst 83 of the cathode electrodes 78. The semiconductors 87 are connected between each cathode and anode and as in the earlier embodiments and allow the transfer of electrons from the cathode stack to the anode stack. The fuel cell elements in the stack shown in FIG. 5 are electrically connected in parallel to complete the electronic circuit. An electrical conductor 88 connects adjacent cathodes 78 and an electrical conductor 89 connects adjacent anodes 77.

This embodiment is shown with the separate semiconductor of the type shown in schematic view of FIG. 1A but it may also be constructed with the type of separate semiconductor arrangement shown in FIG. 1B.

Heat is produced during the fuel cell reaction. Part of this heat is used for pre-heating the hydrogen and the oxygen or oxygen-nitrogen feed to the fuel cell. Excess heat from the fuel cell may be used for external application such as domestic or industrial heating or water desalination.

It is desirable to have the largest specific surface of the electrodes to achieve the highest possible power density for a given volume of the fuel cell. The active surfaces of the anode and cathode electrodes may be grooved or of pyramidal structure to give a high specific surface area of the catalysts.

Throughout this specification various indications have been given as to the scope of this invention but the invention is not limited to any one of these but may reside in two or more of these combined together. The examples are given for illustration only and not for limitation.

Throughout this specification and the claims that follow unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

1. A proton exchange fuel cell comprising an anode, a cathode, a proton exchange material that allows movement of hydrogen ions from the anode to the cathode and a separate semiconductor arrangement electrically connected to the anode and the cathode and which allows movement of electrons from the cathode to the anode.

2. A fuel cell as in claim 1 wherein the proton exchange material is fused to the anode and the cathode.

3. A fuel cell as in claim 2 wherein the proton exchange material is fused to the anode and the cathode by a process selected from the group comprising gluing, welding, brazing and soldering.

4. A fuel cell as in claim 1 wherein the separate semiconductor arrangement comprises a semiconductor bridge.

5. A fuel cell as in claim 1 wherein the semiconductor arrangement comprises a separate semiconductor layer between the anode and proton exchange material or between the proton exchange material and the cathode.

6. A fuel cell as in claim 1 wherein the anode has a catalytic surface adapted to catalyse hydrogen to hydrogen ions.

7. A fuel cell as in claim 6 wherein the anode catalytic surface is fine platinum.

8. A fuel cell as in claim 1 wherein the cathode has a catalytic surface.

9. A fuel cell as in claim 8 wherein the cathode catalytic surface is selected from the group comprising platinum and nickel.

10. A fuel cell as in claim 1 wherein the anode comprises a frusto-conical surface on an inner surface thereof and the cathode comprises a frusto-conical surface on an outer surface thereof and matching the frusto-conical inner surface of the anode, the proton exchange material being held between the frusto-conical inner surface and the frusto-conical outer surface.

11. A fuel cell comprising an anode cell and an anode at one wall thereof, a cathode cell and a cathode at one wall thereof and a proton exchange material between the anode cell and the cathode cell and engaged against the anode and the cathode and a separate semiconductor arrangement electrically connected to the anode and the cathode and which allows movement of electrons from the cathode to the anode.

12. A fuel cell as in claim 11 wherein the proton exchange material is fused to the anode and the cathode.

13. A fuel cell as in claim 11 wherein the semiconductor arrangement comprises a semiconductor bridge.

14. A fuel cell as in claim 11 wherein the semiconductor arrangement comprises a separate semiconductor layer between the anode and proton exchange material or between the proton exchange material and the cathode.

15. A fuel cell as in claim 11 wherein the anode surface within the anode cell has a catalytic surface adapted to catalyse hydrogen to hydrogen ions.

16. A fuel cell as in claim 15 wherein the anode catalytic surface is fine platinum.

17. A fuel cell as in claim 11 wherein the cathode surface with the cathode cell has a catalytic surface selected from the group comprising platinum and nickel.

18. A fuel cell as in claim 11 wherein the cathode and anode are formed from material which allows easy passage of hydrogen ions.

19. A fuel cell as in claim 18 wherein the cathode and anode are formed from a material selected from the group comprising carbon, metal hydrides, metal carbides or alloys thereof.

20. A fuel cell as in claim 11 wherein the cathode and the anode are formed from a material which allows easy passage of hydrogen and the anode has a catalytic surface engaged against the proton exchange material.

21. A fuel cell including an anode having an angled face, a cathode having a complimentary angled face and a proton exchange material between the angled face of the anode and the complimentary angled face of the cathode and force means to draw the angled faces together with the proton exchange engaged therebetween and a separate semiconductor arrangement electrically connected to the anode and the cathode and which allows movement of electrons from the cathode to the anode.

22. A fuel cell as in claim 21 wherein the proton exchange material is fused to the anode and the cathode.

23. A fuel cell as in claim 21 wherein the semiconductor arrangement comprises a semiconductor bridge.

24. A fuel cell as in claim 21 wherein the semiconductor arrangement comprises a separate semiconductor layer between the anode and proton exchange material or between the proton exchange material and the cathode.

25. A fuel cell as in claim 21 wherein the cathode is cylindrical and the angled face is an internal frusto-conical surface and the cathode is cylindrical and the complimentary angled surface is an external frusto-conical surface and the force means causes engagement of the internal frusto-conical surface and the external frusto-conical surface with the proton exchange material sandwiched therebetween.

26. A fuel cell as in claim 21 wherein the proton exchange material is selected from a group comprising a polymer, a rubber or a ceramic.

27. A fuel cell as in claim 21 wherein a surface of each of the anode and cathode not being the angled faces has an increased surface area by means including grooving, pyramiding or roughening of the surface.

28. A fuel cell as in claim 21 wherein the anode and the cathode are formed from material permeable to protons being selected from a group comprising carbon or metal hydrides.

29. A fuel cell as in claim 21 wherein active surfaces of each of the anode and cathode include a catalyst.

30. A fuel cell as in claim 29 wherein the catalyst is fine platinum.

31. A fuel cell as in claim 21 wherein the cathode and the anode are formed from a material which allows easy passage of hydrogen and the anode has a catalytic surface engaged against the proton exchange material.

32. A proton exchange fuel cell arrangement comprising a plurality of fuel cell elements, each fuel cell comprising an anode, a cathode, a proton exchange material that allows movement of hydrogen ions from the anode to the cathode and a separate semiconductor arrangement electrically connected to the anode and the cathode and which allows movement of electrons from the cathode to the anode; and the fuel cell arrangement comprising a simple internal stacking of the fuel cell elements in a cylindrical cell container to allow high pressure hydrogen operation of the fuel cell arrangement.

33. A proton exchange fuel cell arrangement as in claim 32 wherein each anode comprises a cylindrical anode with the frusto-conical surface on inner surface thereof and each cathode comprises a cylindrical cathode with the frusto-conical surface on its outer surface, the cylindrical cathode being within the cylindrical anode.

34. A proton exchange fuel cell arrangement as in claim 32 further comprising means to supply pressurized hydrogen to the anode.

35. A proton exchange fuel cell arrangement as in claim 32 further comprising a manifold within the cylindrical cathode to supply air or oxygen to each of the fuel cell elements.

36. A proton exchange fuel cell arrangement as in claim 35 including means to provide good contact between the oxygen or air and the cathode surface.

37. A proton exchange fuel cell arrangement as in claim 32 further comprising a first manifold within the cylindrical cathode to supply air or oxygen to each of the fuel cell elements and a second manifold within the cylindrical cathode to remove waste products from each of the fuel cell elements.

38. A proton exchange fuel cell arrangement as in claim 37 including means to provide good contact between the oxygen or air and the cathode surface.

39. A proton exchange fuel cell arrangement as in claim 32 wherein the fuel cell elements are electrically connected in series.

40. A proton exchange fuel cell arrangement as in claim 32 wherein the fuel cell elements are electrically connected in parallel.

41. A proton exchange fuel cell arrangement as in claim 32 including annular non-conducting seals between the fuel cell elements, the seals incorporating electrical connections between the adjacent fuel cells.

42. A proton exchange fuel cell arrangement as in claim 32 including force application means on the stack of fuel cell elements to promote sealing at each of the annular seals and to promoting engagement of the respective anodes and cathodes to the proton exchange materials therebetween.

43. A fuel cell as in claim 32 wherein the proton exchange material is fused to the anode and the cathode.

44. A fuel cell as in claim 32 wherein the semiconductor arrangement comprises a semiconductor bridge.

45. A fuel cell as in claim 32 wherein the semiconductor arrangement comprises a separate semiconductor layer between the anode and proton exchange material or between the proton exchange material and the cathode.

46. A process to produce electricity from the reaction of hydrogen and oxygen to produce water in a proton exchange fuel cell arrangement as in claim 32, the process including the steps of:
d) pressurising hydrogen at the outer catalyst surface of the outer cylindrical anode;
e) catalysing the hydrogen to hydrogen ions and electrons at the outer catalyst surface of the outer cylindrical anode wherein the electrons travel from the anode to an external electrical circuit through an electrical load to an inner cylindrical cathode through the semiconductor to the anode and the hydrogen ions travel through the anode, the proton exchange material between the anode and the cathode and the cathode to an inner catalytic surface of the cathode; and
f) reacting the hydrogen ions with oxygen at the inner catalytic surface of the cathode to produce water.

47. A process as in claim 46 wherein the hydrogen is at a pressure of up to 333 bars at the anode.

48. A process as in claim 46 wherein the oxygen is provided at a pressure up to 10 bars at the cathode.

49. A process as in claim 46 wherein the proton exchange fuel cell arrangement is operated at a temperature of up to 250° C.

50. A process as in claim 46 wherein the cathode and the anode are each formed from a material which allows the passage of protons and are formed from a material selected from the group comprising carbon and metal hydrides.

51. A process as in claim 46 wherein the catalytic surface of the anode and the cathode are each platinum.

52. A process as in claim 46 wherein the anode is permeable to hydrogen and the catalytic surface of the anode is the angled face engaged against the proton exchange material whereby impurities in the hdrogen do not poison the catalytic surface.
